(19) United States
(12) Patent Application Publication
(10) Pub. No.: US 2014/0078893 A1
(43) Pub. Date: Mar. 20, 2014

(54) ROUTER, SYSTEM AND METHOD FOR NETWORK RECOVERY

(71) Applicants: AMBIT MICROSYSTEMS (SHANGHAI) LTD., Shanghai (CN); HON HAI PRECISION INDUSTRY CO., LTD., New Taipei (TW)

(72) Inventor: ZHI MEI, Shanghai (CN)

(73) Assignees: HON HAI PRECISION INDUSTRY CO., LTD., New Taipei (TW); AMBIT MICROSYSTEMS (SHANGHAI) LTD., Shanghai (CN)

(21) Appl. No.: 13/863,395

(22) Filed: Apr. 16, 2013

(30) Foreign Application Priority Data
Sep. 19, 2012 (CN) 201210351792.8

(51) Int. Cl. H04L 12/24

(52) U.S. Cl. CPC H04L 41/0668
USPC 370/228

(57) ABSTRACT

A network-recovering router is provided. The router includes a first network port and a second network port. If the router determines that a communication link between the first network port and a remote device is broken, the router generates a modified information packet and transmits the modified information packet to the remote device to inform the remote device of a new communication link via the second network port of the router, effectively preventing any interruption of the data flow. A system and method for network recovery are also provided.

### BACKGROUND

1. Technical Field

The present disclosure relates to networks, and particularly, to a router and a system and method capable of network recovery.

2. Description of Related Art

Routers are important in a network communication. A router may communicate with at least one remote device. However, when a communication link between the router and the remote device is broken, a data transmission between the router and the remote device is interrupted. When a new communication link is established, data has to be re-transmitted from the beginning, which is time-consuming.

Therefore, it is desirable to provide a router and a method to resolve the above shortcomings.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a block diagram of a router communicating with a remote device in accordance with an exemplary embodiment.

FIG. 2 is a schematic diagram showing how the router of FIG. 1 communicates with the remote device of FIG. 1.

FIG. 3 is a flowchart of a method for network recovery, in accordance with an exemplary embodiment.

### DETAILED DESCRIPTION

Embodiments of the present disclosure will be described with reference to the accompanying drawings.

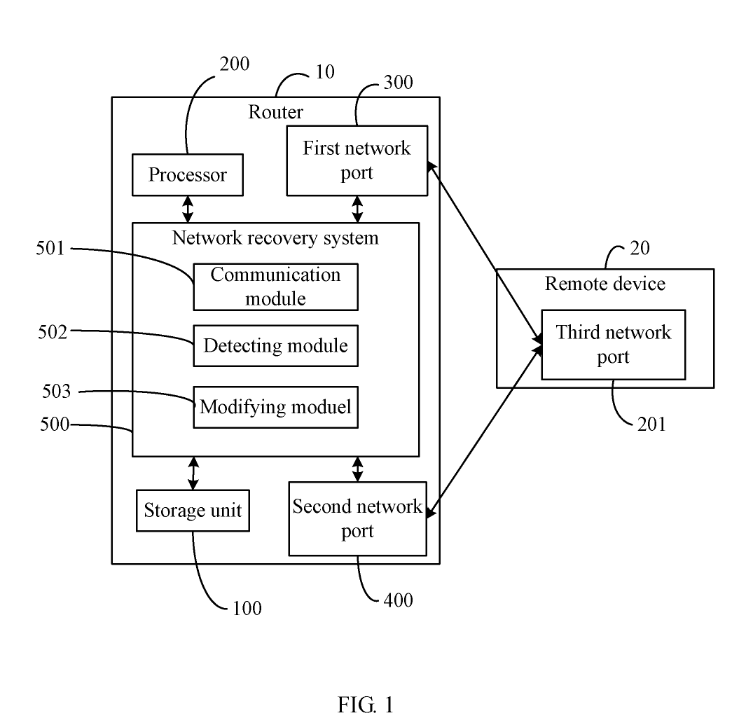

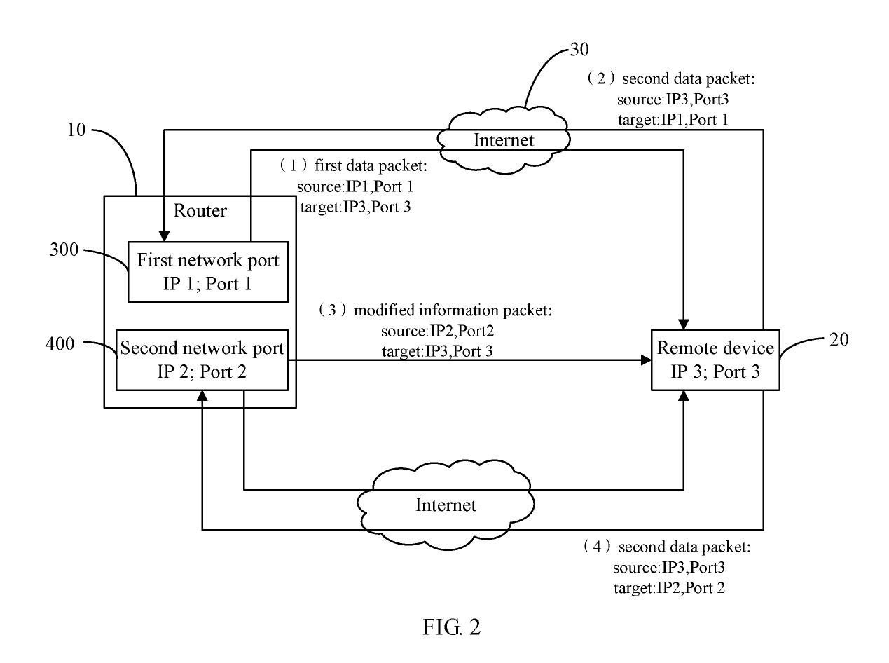

Referring to FIGS. 1-2, in an embodiment of the present disclosure, a router 10 is connected to at least one remote device 20 via a network 30. In this embodiment, the network 30 is a wide area network (WAN). The router 10 includes a storage unit 100, a processor 200, and at least two network ports. In this embodiment, the router 10 includes a first network port (hereinafter the first port) 300 and a second network port (hereinafter the second port) 400. The first port 300 is assigned a first port number and a first IP address. The second port 400 is assigned a second port number and a second IP address. Each remote device 20 includes a third port 201, and the third port 201 is assigned a third port number and a third IP address. The router 10 communicates with the remote device 20 via one of the first port 300 and the second port 400.

The storage unit 100 may be a smart media card, a secure digital card, or a flash card. The storage unit 100 stores computerized codes of a network recovery system 500. The network recovery system 500 includes various software components and/or set of instructions, which may be implemented by the processor 200 to recover network connection when the communication link between the router 10 and the remote device 20 is broken.

The network recovery system 500 includes a communication module 501, a detecting module 502, and a modifying module 503.

The communication module 501 includes various components and/or set of instructions, which may be implemented by the processor 200, to exchange data packets with the remote device 20 by the first port 300 or by the second port 400 communicating with the third port 201 of the remote device 20. In this embodiment, each data packet includes a source IP address, a source port number, a target IP address, and a target port number. The source IP address and the source port number indicates which network port the data packet was sent from, the target IP address and the target port number indicates the network port destination.

In this embodiment, the communication module 501 is implemented by the processor 200 to communicate with the remote device 20 firstly via the first port 300. The communication module 501 is implemented by the processor 200 to send a first data packet to the third port 201 via the first port 300. The source IP address included in the first data packet is the IP address of the first port 300, and the source port number included in the first data packet is the port number of the first port 300. The target IP address included in the first data packet is the IP address of the third port 201, and the target port number included in the first data packet is the port number of the third port 201. When the remote device 20 receives the first data packet sent by the communication module 501, the remote device 20 obtains the source IP address and the source port number included in the first data packet, generates a second data packet according to the first data packet, and transmits the second data packet to the first port 300 via the third port 201. The source IP address of the second data packet is the IP address of the third port 201, and the source port number of the second data packet is the port number of the third port 201. The target IP address of the second data packet is the IP address of the first port 300, and the target port number of the second data packet is the port number of the first port 300. Thus, data packets are exchanged between the first port 300 and the third port 201. In this embodiment, each data packet includes a unique identification code.

The detecting module 502 includes various software components and/or set of instructions, which may be implemented by the processor 200 to check when the communication link between the first port 300 and the third port 201 is broken. In this embodiment, the detecting module 502 uses known Internet Control Message Protocol (ICMP) to check if the communication link between the first port 300 and the third port 201 is broken.

If the detecting module 502 determines that the communication link between the first port 300 and the third port 201 is broken, the modifying module 503 obtains the unique identification code, the source IP address and the source port number of the most recent data packet before the communication link was disconnected, generates a modified information packet according to the obtained information, and transmits the modified information packet to the remote device 20 to inform the remote device 20 that a new communication link will be established via the second port 400. In the embodiment, the modified information packet includes the unique identification code of the most recent data packet, the IP address and the port number of the first port 300 communicating with the remote device 20, and the IP address and the port number of the second port 400.

The communication module 501 sends the modified information packet to the remote device 20 via the second port 400. The source IP address of the modified information packet is the IP address of the second port 400, and the source port number of the modified information packet is the port number of the second port 400. The target IP address included in the modification information data packet is the IP address of the third port 201, the target port number included in the modification information data packet is the port number of the third port 201.

When the remote device 20 receives the modified information packet sent by the second port 400, the remote device 20 obtains the unique identification code of the most recent data packet, the IP address and the port number of the first port 300, the IP address and the port number of the second port 400, and generates a third data packet according to the information obtained from the modification information packet. The target IP address of the third data packet is the IP address of the second port 400, the target port number is the port number of the second port 400, and data included in the third data packet is a continuation or duplicate of the data included in the most recent data packet before the communication link was broken. The remote device 20 sends the third data packet to the second port 400. Thus, the router 10 can automatically switch to communication with the remote device 20 via the second port 400 from the first port 300 when the communication link between the first port 300 and the remoter device 20 is broken. The transmission of data will be effectively uninterrupted if a communication link between the first port 300 and the remote device 20 is broken.

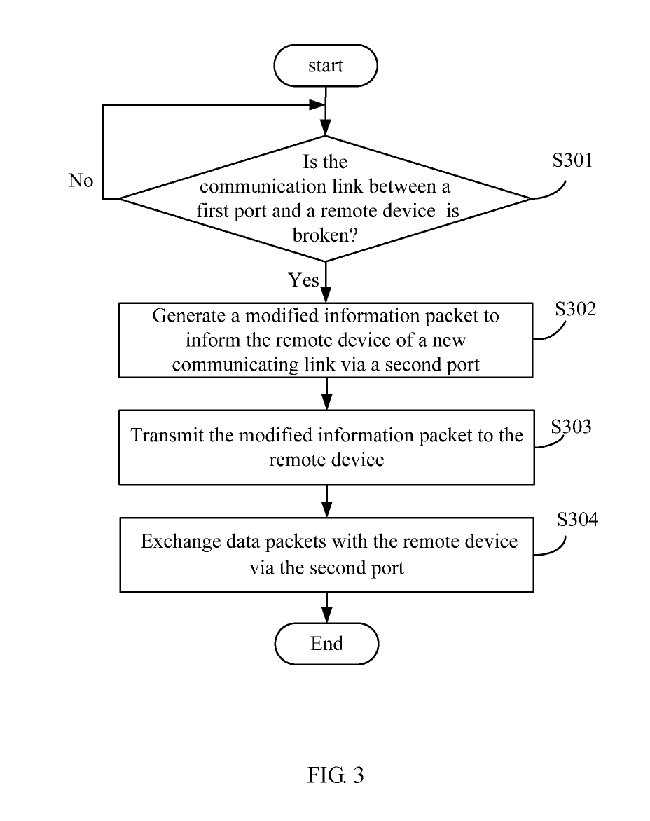

FIG. 3 is a flowchart of a method for network recovery, in accordance with an exemplary embodiment.

In step S301, the detecting module 502 is aware of any communication link between the first port 300 and the third port 201 being broken.

In step S302, if the detecting module 502 determines that a communication link between the first port 300 and the third port 201 is broken, the modifying module 503 obtains the unique identification code, the source IP address and the source port number of the most recent data packet before the communication link was broken, and generates a modified information packet according to the obtained information.

In step S303, the communication module 501 transmits the modified information packet to the remote device 20 via the second port 400 to inform the remote device 20 that a new communication link will be established via the second port 400.

In step S304, the communication module 501 exchanges data packets with the remote device 20 via the second port 400.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A router for communicating with a remote device via a network, the router comprising:
a storage unit;
a processor;
a first network port;
a second network port; and
a network recovery system comprising computerized code in the form of one or more programs, which are stored in the storage unit and executable by the processor, the one or more programs comprising:
a communication module operable to exchange data packets with the remote device via the first network port;
a detecting module operable to check whether a communication link between the router and the remote device is broken; and
a modifying module operable to generate a modified information packet when the communication link between the router and the remote device is broken, and transmit the modified information packet to the remote device to inform the remote device that a new communication link will be established via the second network port, the modified information packet comprising an IP address and a port number of the first network port communicating with the remote device before the communication link is broken, and an IP address and a port number of the second network port will be used to communicate with the remote device when the communication link is broken.

2. The router as described in claim 1, wherein the modified information packet further comprises a unique identification code of most recent data packet.

3. A network recovery system applied in a router, the router comprising a first network port and a second network port, the network recovery system comprising:
a communication module operated by a processor to exchange data packets with the remote device via the first network port;
a detecting module operated by the processor to check whether a communication link between the router and the remote device is broken; and
a modifying module operated by the processor to generate a modified information packet when the communication link between the router and the remote device is broken, and transmit the modified information packet to the remote device to inform the remote device that a new communication link will be established via the second network port of the router, the modified information packet comprising an IP address and a port number of the first network port communicating with the remote device before the communication link is broken, and an IP address and a port number of the second network port will be used to communicate with the remote device when the communication link is broken.

4. The network recovery system as described in claim 3, wherein the modified information packet further comprises a unique identification code of most recent data packet.

5. A method for network recovery applied in a router, the router communicating with at least one remote device via a network, the router comprising a first network port and a second network port, the method comprising:
checking whether a communication link between the first network port of the router and the remote device is broken;
generating a modified information packet if the communication link between the router and the remote device is broken,; and
transmitting the modified information packet to the remote device to inform the remote device that a new communication link will be established via the second network port of the router; and
exchanging data packets with the remote device via the new communication link.

6. The method as described in claim 5, wherein the modified information packet further comprises a unique identification code of most recent data packet.
